(19) United States
(12) Patent Application Publication
(10) Pub. No.: US 2009/0188749 A1
(43) Pub. Date: Jul. 30, 2009

(54) SAFETY HARNESS

(76) Inventor: Rong-Der Hong, Taichung (TW)

Correspondence Address: BUTZEL LONG;IP DOCKETING DEPT, 350 SOUTH MAIN STREET, SUITE 300, ANN ARBOR, MI, 48104, US

(21) Appl. No.: 12/111,401

(22) Filed: Apr. 29, 2008

(30) Foreign Application Priority Data
Jan. 24, 2008 (TW) 097201547

(51) Int. Cl. A62B 35/00

(52) U.S. Cl. 182/3

(57) ABSTRACT

A safety harness includes a safety belt unit having a pair of shoulder straps, a connecting belt having one end connected to the safety belt unit, and a hook-engaging member connected to the connecting belt. The hook-engaging member has a loop body confining a loop space therein, and a collar extending from the loop body into the loop space.

### CROSS-REFERENCE TO RELATED APPLICATION

This application claims priority of Taiwanese Application No. 097201547, filed on Jan. 24, 2008.

### BACKGROUND OF THE INVENTION

1. Field of the Invention

This invention relates to a safety harness, more particularly to a safety harness for industrial or construction workers.

2. Description of the Related Art

When industrial or construction workers are working at dangerous heights above the ground, they must wear some sort of safety gear to restrain themselves from falling down at elevated heights.

Referring to FIG. 1, a conventional safety harness 1 includes a pair of shoulder straps 11 crossing over the shoulders of an industrial worker, a pair of waist straps 12, and a harness ring 13 that is coupled releasably to a suspending rope 2 and that is disposed at a location where the shoulder straps 11 cross each other. The safety harness 1 is releasably anchored onto an anchoring device 3 via the suspending rope 2. Since the harness ring 13 is disposed on the worker's back, it is hard to reach. Referring to FIG. 2, in order to remedy the problem of accessibility of the harness ring 13, the safety harness 1 may further include a connecting belt 14 connected to the harness ring 13, and an auxiliary harness ring 15 connected to the connecting belt 14. The auxiliary harness ring 15 is connected to the suspending rope 2.

The worker can release him or herself from the anchoring device 3 by disconnecting the suspending rope 2 from the auxiliary harness ring 15. As such, the connecting belt 14 and the auxiliary harness ring 15 loosely dangle from the harness ring 13. To avoid such dangling, the worker typically pulls the connecting belt 14 over one shoulder and tucks the auxiliary harness ring 15 under one of the shoulder straps 11, as shown in FIG. 3. However, such tucking of the auxiliary harness ring 15 under one of the shoulder straps 11 does not result in the auxiliary harness ring 15 being securely strapped down. Therefore, the auxiliary harness ring 15 may be removed from under the shoulder strap 11 at any time, in which case the auxiliary harness ring 15 and one end of the connecting belt 14 would dangle from the shoulder of the worker and thereby compromise the safety of the worker.

### SUMMARY OF THE INVENTION

It is an object of the present invention to provide a safety harness that can overcome the above drawbacks of the prior art.

According to the present invention, a safety harness includes a safety belt unit having a pair of shoulder straps, a connecting belt having one end connected to the safety belt unit, and a hook-engaging member connected to the connecting belt. The hook-engaging member has a loop body confining a loop space therein, and a collar extending from the loop body into the loop space.

### BRIEF DESCRIPTION OF THE DRAWINGS

Other features and advantages of the present invention will become apparent in the following detailed description of the preferred embodiment with reference to the accompanying drawings, of which:

FIG. 1 shows a conventional safety harness in a state worn by an industrial worker;

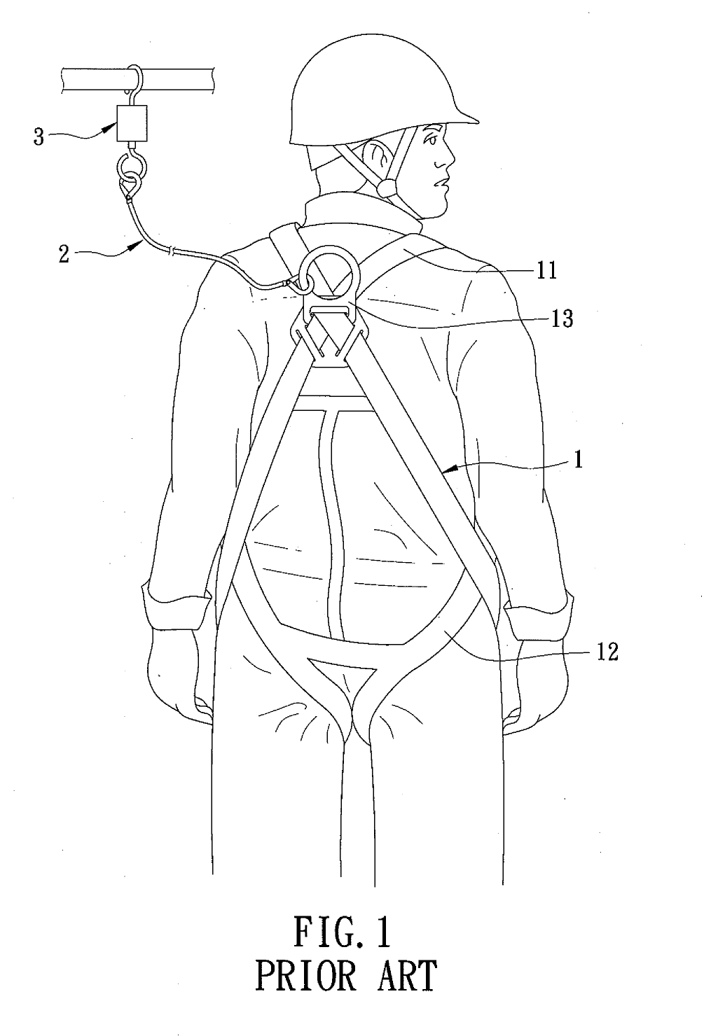

FIG. 2 shows the conventional safety harness of FIG. 1 when further equipped with a connecting belt and an auxiliary harness ring;

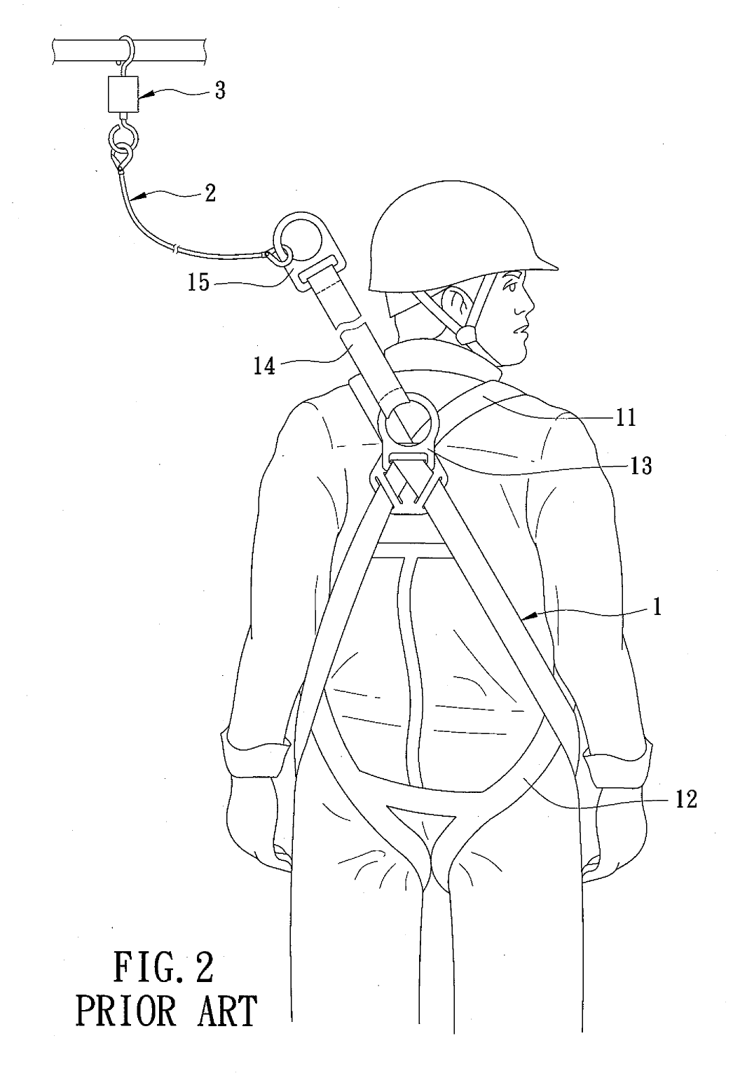

FIG. 3 is a fragmentary schematic view of the conventional safety harness of FIG. 2, illustrating how the auxiliary harness ring may be tucked under a shoulder strap;

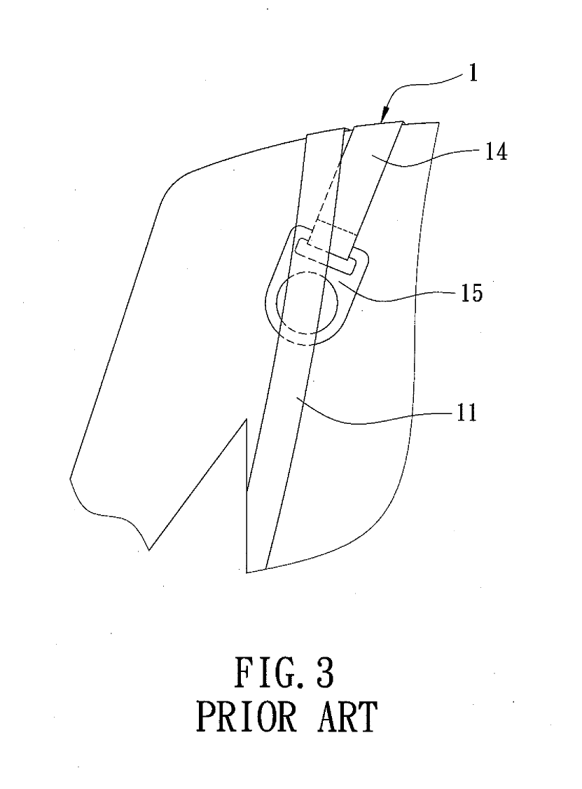

FIG. 4 shows the preferred embodiment of a safety harness of the present invention in a state worn by an industrial worker and anchored to an anchoring device via a suspending rope;

FIG. 5 shows a hook-engaging member of the safety harness according to the preferred embodiment of the present invention;

FIG. 6 is a fragmentary schematic view of the preferred embodiment, illustrating how the hook-engaging member may be secured to a shoulder strap; and

FIG. 7 is a view similar to FIG. 6, but illustrating a modified example of the hook-engaging member.

### DETAILED DESCRIPTION OF THE PREFERRED EMBODIMENT

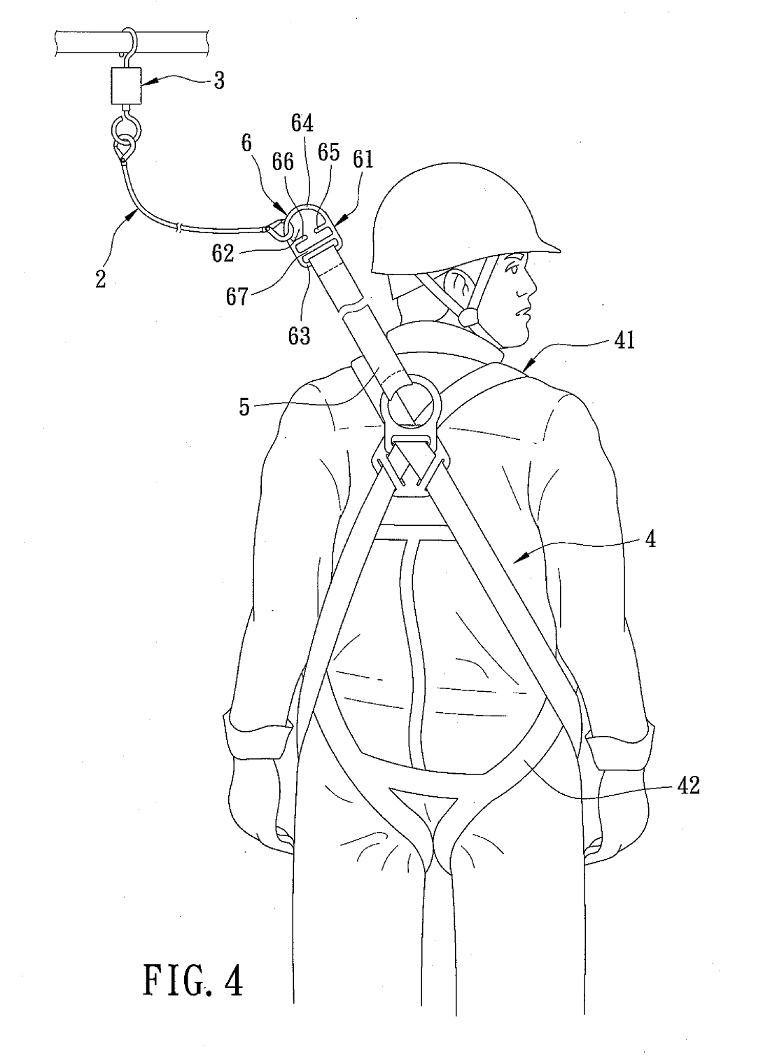

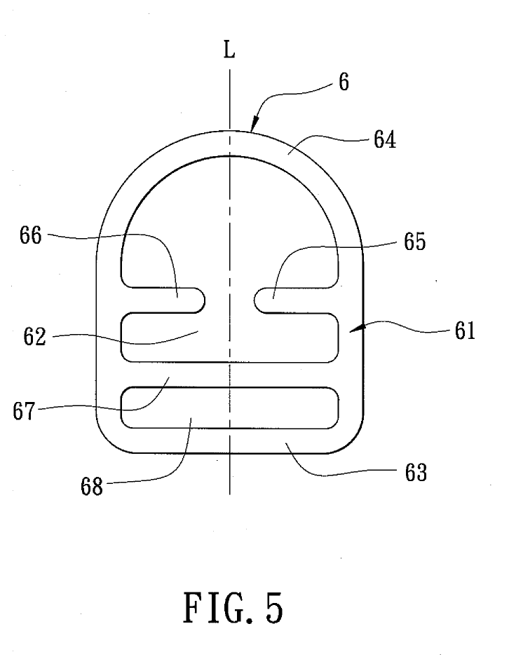

Referring to FIGS. 4 and 5, the preferred embodiment of a safety harness according to the present invention can be worn by an industrial worker and is anchored to an anchoring device 3 via a suspending rope 2. The safety harness includes a safety belt unit 4 having a pair of shoulder straps 41 placed over the shoulders of the industrial worker, a pair of waist straps 42 wrapped around the industrial worker's waist, a connecting belt 5 having one end connected to the safety belt unit 4, and a hook-engaging member 6 connected to the other end of the connecting belt 5. The shoulder straps 41 and the waist straps 42 are made of a durable fabric material. The hook-engaging member 6 has a loop body 61 confining a loop space 62 therein, and a first collar 65 extending from the loop body 61 into the loop space 62. The loop body 61 has opposite lateral sides that extend parallel to an axis of symmetry (L) of the hook-engaging member 6, a connecting side 63 interconnecting the opposite lateral sides, and an arcuate side 64 that interconnects the opposite lateral sides, that curves about the axis of symmetry (L), and that is opposite to the connecting side 63. The first collar 65 extends from one of the lateral sides.

In the preferred embodiment, the opposite lateral sides, the connecting side 63, and the arcuate side 64 cooperate with each other to form a D-shaped enclosure. The D-shaped enclosure is coupled to the suspending rope 2. Due to the fact that the arcuate side 64 has a curved contour, when the suspending rope 2 exerts forces on the arcuate side 64, the forces can be distributed uniformly therealong resulting in a secure and stable engagement.

The hook-engaging member 6 further has a limiting crossbar 67 that is disposed between the connecting side 63 and the first collar 65 and that interconnects the opposite lateral sides. The connecting belt 5 is looped around the connecting side 63 and passes through a space 68 that is cooperatively defined by the limiting crossbar member 67, the connecting side 63, and the opposite lateral sides.

In the preferred embodiment, the hook-engaging member 6 is made of a metal material and further has a second collar 66 that extends from the loop body 61 into the loop space 62 and that is spaced apart from the first collar 65.

In the preferred embodiment, the first and second collars 65, 66 are symmetrical. That is, in the preferred embodiment, the first and second collars 65, 66 are aligned horizontally such that the hook-engaging member 6 is symmetrical about the axis of symmetry (L) It is noted that the second collar 66 is optional and can be omitted from the structure of the hook-engaging member 6 of the present invention. That is, by using only the arcuate side 64, the first collar 65, and the limiting crossbar 67, the hook-engaging member 6 can still be secured to the safety belt unit 4.

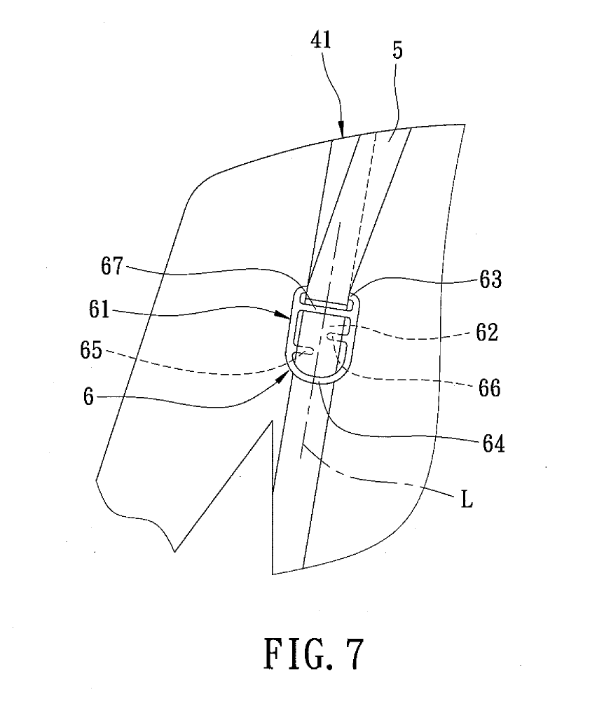

In a modified example of the preferred embodiment, the first and second collars 65, 66 are asymmetrical (not symmetrical), as shown in FIG. 7. That is, in the modified example of the preferred embodiment, the first and second collars 65, 66 are offset horizontally such that the hook-engaging member 6 is no longer symmetrical about the axis (L). As a result, the hook-engaging member 6 can be more easily engaged with the shoulder straps 41.

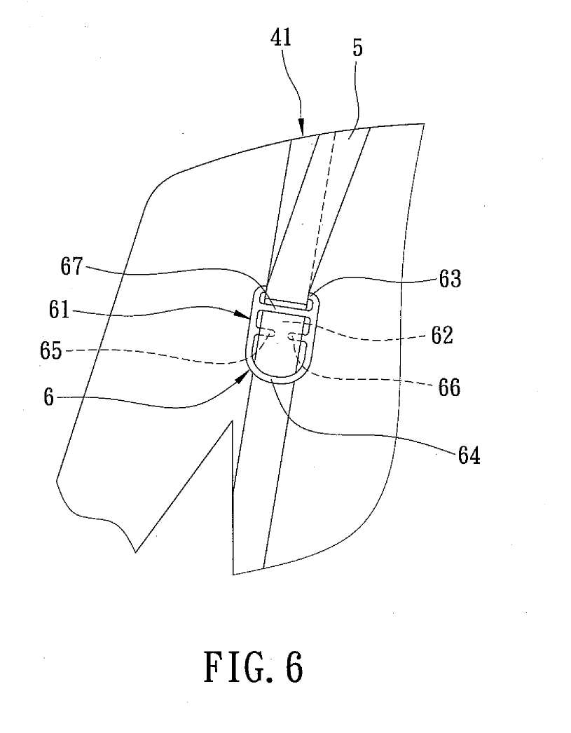

Through use of the safety harness of the present invention, the worker can release him or herself from the anchoring device 3 by simply disconnecting the suspending rope 2 from the hook-engaging member 6. Next, the connecting belt 5 may be placed over one shoulder and the hook-engaging member 6 may be attached to one of the shoulder straps 41, as shown in FIG. 6. Due to such engagement of the hook-engaging member 6 with one of the shoulder straps 41 when the worker is not connected to the anchoring device 3, the dangers associated with the connecting belt 5 and the hook-engaging member 6 being in a dangling state can be avoided.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A safety harness comprising:
a safety belt unit including a pair of shoulder straps;
a connecting belt having one end connected to said safety belt unit; and
a hook-engaging member connected to said connecting belt and having a loop body confining a loop space therein, and a first collar extending from said loop body into said loop space.

2. The safety harness as claimed in claim 1, wherein said hook-engaging member further has a second collar extending from said loop body into said loop space and spaced apart from said first collar.

3. The safety harness as claimed in claim 2, wherein said first and second collars are symmetrical.

4. The safety harness as claimed in claim 2, wherein said first and second collars are asymmetrical.

5. The safety harness as claimed in claim 1, wherein said loop body has opposite lateral sides, a connecting side interconnecting said opposite lateral sides, and an arcuate side interconnecting said opposite lateral sides and opposite to said connecting side, said first collar extending from one of said lateral sides.

6. The safety harness as claimed in claim 5, wherein said hook-engaging member further has a limiting crossbar disposed between said connecting side and said first collar and interconnecting said opposite lateral sides, said connecting belt being looped around said connecting side.
